(19) United States
(12) Patent Application Publication
(10) Pub. No.: US 2022/0119970 A1
(43) Pub. Date: Apr. 21, 2022

(54) METHOD FOR PREPARING METAL CATALYST

(71) Applicant: PUSAN NATIONAL UNIVERSITY INDUSTRY-UNIVERSITY COOPERATION FOUNDATION, Busan (KR)

(72) Inventors: Hyun Deog YOO, Seoul (KR); Sol Jin KIM, Busan (KR); Ki Min NAM, Busan (KR); Heon Cheol SHIN, Busan (KR); Sangram Keshari MOHANTY, Busan (KR)

(73) Assignee: PUSAN NATIONAL UNIVERSITY INDUSTRY-UNIVERSITY COOPERATION FOUNDATION, Busan (KR)

(21) Appl. No.: 17/507,235

(22) Filed: Oct. 21, 2021

(30) Foreign Application Priority Data
Oct. 21, 2020 (KR) 10-2020-0136442

(51) Int. Cl. C25D 1/00; B01J 37/02; B01J 35/10; C25D 21/14; B01J 23/50; B01J 37/34

(52) U.S. Cl. CPC C25D 1/00; B01J 37/0215; B01J 37/348; C25D 21/14; B01J 23/50; B01J 35/10

(57) ABSTRACT

A method for producing a metal catalyst, including applying an anodic current with a positive (+) sign to form a metal oxide having a bipyramidal shape, and then applying a cathodic current with a negative (−) sign or applying a potential in a negative (−) direction to form uniform atomic scale pores on the surface and inside of the metal particles, and controlling the amount of oxygen remaining in the metal to modify the metal surface.

### CROSS-REFERENCE TO PRIOR APPLICATION

The present application claims priority to Korean Patent Application No. 10-2020-0136442 (filed on Oct. 21, 2020), which is hereby incorporated by reference in its entirety.

### BACKGROUND

The present disclosure relates to a method for producing a metal catalyst, and more specifically, a method for producing a metal catalyst having increased catalytic activity and active area, the method including applying anodic current to form a metal oxide having a bipyramidal shape, and then applying cathodic current or applying a potential to a negative (−) direction to form uniform atomic scale pores on the surface and inside of the metal particles, and controlling the amount of oxygen remaining in the metal to modify the metal surface.

An oxygen reduction reaction occurring at the positive electrode of a metal-air cell or a fuel cell necessarily requires a catalyst due to a strong oxygen double bond. For the development of the above-described catalyst, transition metal particles having high catalytic activity have been used.

In general, the performance of a catalyst is proportional to the original activity and electrochemically active surface area of the catalyst.

Therefore, synthesis of a non-platinum-based transition metal catalyst having an optimal activity and a large specific surface area as a result of controlling the fundamental physical properties and porosity of the surface thereof at the atomic scale is industrially very important.

In order to maximize the electrochemically active surface area of a catalyst, a method of impregnating the metal nanoparticles on a porous support such as carbon has been mainly used. However, this method has a problem in that the active area of the catalyst gradually decreases due to the chemical/electrochemical instability of the support and the Ostwald ripening of the metal nanoparticles.

Meanwhile, a method of electrodepositing metal nanoparticles on a conductive support by applying a reducing current has a limitation in increasing the surface area of the metal itself, and also has a disadvantage in that it is difficult to finely control the physical properties of the surface. For example, many attempts have been made to improve the electrodeposition process by adjusting the concentration of a solution or adding an additive such as EDTA during the process of electrodepositing silver particles by applying a reducing current, but there are still limitations in that the original catalytic activity is low and the catalytic active area is small.

Therefore, in order to overcome the above-described problems, the present inventors recognized that it is urgent to develop a method for producing a catalyst, which increases the active area of the catalyst by forming atomic scale pores inside metal particles, thereby completing the present disclosure.

### PRIOR ART DOCUMENTS

### Patent Documents

(Patent Document 1) Korean Patent No. 10-0413632

(Patent Document 2) Korean Patent No. 10-0426159

### SUMMARY

An object of the present disclosure is to provide a method for producing a metal catalyst having increased catalytic activity and active area, the method including applying an anodic current with a positive (+) sign to form a metal oxide having a bipyramidal shape, and then applying a cathodic current with a negative (−) sign or applying a potential in a negative (−) direction to form uniform atomic scale pores on the surface and inside of the metal particles, and controlling the amount of oxygen remaining in the metal to modify the metal surface.

Another object of the present disclosure is to provide a metal catalyst produced by the method for producing a metal catalyst having increased catalytic activity and active area, the method including applying an anodic current with a positive (+) sign to form a metal oxide having a bipyramidal shape, and then applying a cathodic current with a negative (−) sign or applying a potential in a negative (−) direction to form uniform atomic scale pores on the surface and inside of the metal particles, and controlling the amount of oxygen remaining in the metal to modify the metal surface.

Objects to be achieved by the present disclosure are not limited to the above-mentioned objects, and other objects not mentioned herein can be clearly understood by those of ordinary skill in the art from the description of the present disclosure.

To achieve the above object, the present disclosure provides a method for producing a metal catalyst.

Hereinafter, the present disclosure will be described in more detail.

The present disclosure provides a method for producing a metal catalyst, the method including steps of:

(S1) electrodepositing a metal oxide on a working electrode by applying an anodic current to the working electrode; and

(S2) producing a metal catalyst having pores formed therein by applying a cathodic current or applying a potential in a negative (−) direction to the working electrode having the metal oxide electrodeposited thereon.

In the present disclosure, the anodic current may be applied in the form of a pulse by applying a current of +20 to +60 mA/cm², pausing at 0 mA/cm², and repeating the application of the current and the pausing.

In the present disclosure, step (S1) may include steps of:

(S1A) placing the working electrode and a counter electrode in a first electrolyte solution containing a metal ion; and

(S1B) electrodepositing the metal oxide on the surface of the working electrode by applying the anodic current to the working electrode.

In the present disclosure, the method may further include, after step (S1), a step of replacing the first electrolyte solution containing the metal ion with a second electrolyte solution containing no metal ion.

The present disclosure also provides a metal catalyst produced by the method for producing a metal catalyst.

All details mentioned in the method for producing a metal catalyst and in the metal catalyst produced are equally applied as long as they do not contradict one another.

According to the method for producing a metal catalyst according to the present disclosure and the metal catalyst produced thereby, it is possible to provide a metal catalyst having increased catalytic activity and active area by applying an anodic current to form a metal oxide having a bipyramidal shape, and then applying a cathodic current or applying a potential in a negative (−) direction to form uniform atomic scale pores on the surface and inside of the metal particles, and controlling the amount of oxygen remaining in the metal to modify the metal surface.

The effects of the present disclosure are not limited to the above-mentioned effects, and other effects not mentioned herein will be clearly understood by those skilled in the art from the description of the claims.

### BRIEF DESCRIPTION OF THE DRAWINGS

FIG. 1 shows scanning electron microscopy (SEM) images of a metal oxide (a) and a metal catalyst (b) having pores formed by reducing the metal oxide, produced according to Example 1 of the present disclosure.

FIG. 2 shows X-ray diffraction (XRD) patterns of the metal oxide (a) and the metal catalyst (b) having pores formed by reducing the metal oxide, produced according to Example 1 of the present disclosure.

FIG. 3 depicts X-ray diffraction (XRD) patterns showing the amount of oxygen remaining in the metal catalyst following the application of a reducing potential.

FIG. 4 depicts X-Ray photoelectron spectroscopy (XPS) spectra (a) and ultraviolet photoelectron spectroscopy (UPS) spectra (b) showing the amount of oxygen remaining in a reduced porous metal catalyst.

FIG. 5 is a graph showing the capacitances of the metal oxide and the metal catalyst having pores formed by reducing the metal oxide, produced according to Example 1 of the present disclosure, and a silver (Ag) metal electrodeposited by a conventional method.

FIG. 6 shows the results of performing a rotating disk electrode (RDE) experiment (a) and a cyclic voltammetry experiment in a meniscus configuration (b) to analyze the redox catalytic activities of the metal catalyst produced according to Example 1 of the present disclosure and the silver (Ag) metal produced by a conventional method.

FIG. 7 shows the results of analyzing the carbon dioxide reduction catalytic activities of the metal catalyst (a) produced according to Example 1 of the present disclosure and the silver (Ag) metal (b) produced by a conventional method.

### DETAILED DESCRIPTION

The terms used in the present specification are currently widely used general terms selected in consideration of their functions in the present disclosure, but they may change depending on the intents of those skilled in the art, precedents, or the advents of new technology. Additionally, in certain cases, there may be terms arbitrarily selected by the applicant, and in this case, their meanings are described in a corresponding description part of the present disclosure. Accordingly, terms used in the present disclosure should be defined based on the meaning of the term and the entire contents of the present disclosure, rather than the simple term name.

Unless otherwise defined, all terms used herein, including technical and scientific terms, have the same meaning as commonly understood by those skilled in the art to which the present disclosure belongs. Terms such as those used in general and defined in dictionaries should be interpreted as having meanings identical to those specified in the context of related technology. Unless definitely defined in the present application, the terms should not be interpreted as having ideal or excessively formative meanings.

A numerical range includes numerical values defined in the range. Every maximum numerical limitation given throughout the present specification includes every lower numerical limitation, as if such lower numerical limitations were expressly written herein. Every minimum numerical limitation given throughout the present specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Hereinafter, embodiments of the present disclosure will be described in detail, but it is obvious that the present disclosure is not limited by the following embodiments.

### Method for Producing Metal Catalyst

The present disclosure provides a method for producing a metal catalyst, the method including steps of:

(S1) electrodepositing a metal oxide on a working electrode by applying an anodic or positive (+) current to the working electrode; and

(S2) producing a metal catalyst having pores formed therein by applying a cathodic or negative (−) current or applying a potential in a negative (−) direction to the working electrode having the metal oxide electrodeposited thereon.

The term “working electrode” as used in the present disclosure refers to an electrode, which is used to cause a desired reaction, among electrodes which are used for the purpose of allowing a current to flow into a sample in order to cause an electrode reaction.

The term “counter electrode” as used in the present disclosure refers to an electrode which is positioned against the working electrode and at which a reaction occurs in order to allow a current to flow into a cell.

The term “electrodeposition” as used in the present disclosure refers to a method of depositing a material, such as a metal, an alloy or a compound, on an electrode by electrolysis.

Each of the working electrode and the counter electrode may be made of an electrically conductive carbon material or a porous electrical conductor. More specifically, each of the working electrode and the counter electrode may be made of a carbon material composed of porous carbon paper (CP), glassy carbon (GC), activated carbon cloth (ACC), or carbon nanotubes; or a porous electrical conductor composed of stainless steel or metal mesh material. In addition, the working electrode and the counter electrode may be made of the same material selected from the above-described materials.

Since the working electrode is composed of an electrically conductive porous carbon material or a porous electrical conductor, an electrolyte solution may sufficiently penetrate into the working electrode.

Step (S1) is a step of electroplating a metal oxide on the surface of the working electrode, and may include steps of:

(S1A) placing the working electrode and a counter electrode in a first electrolyte solution containing a metal; and

(S1B) electrodepositing the metal oxide on the surface of the working electrode by applying the anodic or positive (+) current to the working electrode.

The first electrolyte solution containing a metal may be an electrolyte solution containing a transition metal ion, wherein the transition metal may be at least one selected from the group consisting of copper (Cu), silver (Ag), gold (Au), iron (Fe), platinum (Pt), palladium (Pd), titanium (Ti), ruthenium (Ru), iridium (Ir), zinc (Zn), cobalt (Co), vanadium (V), manganese (Mn), and nickel (Ni).

The metal oxide may be electrodeposited on the surface of the working electrode according to the following Formula 1 when a positive (+) current (oxidation current) is applied to the working electrode:

Mⁿ⁺(aq)+xH₂O(l)→MO_{z}(s)+2xH⁺+(2x−n)e⁻ [Formula 1]

In order to control the growth of the metal oxide, the positive (+) current may be applied in the form of a pulse by applying a positive (+) current of +20 to +60 mA for 1 to 5 seconds, pausing at 0 mA for 1 to 10 seconds, and repeating the application of the current and the pausing 10 to 1,000 times. The number of times the positive (+) current is applied may be adjusted depending on the metal ions contained in the electrolyte solution.

The metal oxide may have a polyhedral structure such as a bipyramidal shape.

The method may further include, after step (S1), a step of replacing the first electrolyte solution containing the metal ion with a second electrolyte solution containing no metal ion. More specifically, after completion of step (S1), the first electrolyte solution containing the metal ions may be removed and replaced with a second electrolyte solution free of the metal ions, in order to prevent side reactions from occurring when the cathodic or negative (−) current is applied in step (S2).

The second electrolyte solution containing no metal ions may be at least one selected from the group consisting of sodium chloride (NaCl), sodium hydroxide (NaOH), potassium hydroxide (KOH), and sodium nitrate (NaNO₃), but is not limited thereto as long as it is an electrolyte solution containing no transition metal ions, which is commonly used in the art.

In addition, when the first electrolyte solution is replaced with the second electrolyte solution, the counter electrode may also be replaced with a fresh counter electrode having the same configuration as the counter electrode used in step (S1).

Step (S2) is a step of producing a metal catalyst by applying a negative (−) current (reduction current) to the metal oxide, and in this step, the metal oxide may be reduced according to the following Formula 2. Alternatively, in step (S2), a catalyst may also be produced by scanning the metal oxide with a potential in a negative (−) direction.

MO_{z}(s)+2xH⁺+2xe⁻→M(s)+xH₂O(l) [Formula 2]

In step (S2), micropores may be formed in the surface of the metal catalyst by applying a reducing current or reducing potential to the metal oxide. More specifically, for the formation of the micropores on the surface of the metal catalyst, as a negative (−) current is applied to the metal oxide, oxygen atoms present in the metal oxide escape, and atomic scale voids created by the reaction may form mesopores.

In order to control the amount of the negative (−) current that is applied in step (S2), the amount or time of application of the negative (−) current may be controlled. In addition, it is possible to control the amount of oxygen remaining in the produced metal catalyst by controlling the voltage, at which scanning with the potential in the negative (−) direction is terminated, to a voltage of +0.6 to −0.2 V vs Hg/HgO.

Since the metal catalyst produced by step (S2) has a higher surface area and catalytic activity than the metal oxide of step (S1), it is possible to efficiently utilize metal resources.

The advantages and features of the present disclosure, and the way of attaining them, will become apparent with reference to the examples described below. However, the present disclosure is not limited to the examples disclosed below and may be embodied in a variety of different forms. Rather, these examples are provided so that this disclosure will be thorough and complete, and will fully convey the scope of the present disclosure to those skilled in the art. The scope of the present disclosure will be defined only by the appended claims.

The reagents and solvents mentioned below were purchased from Daejung Chemicals & Metals (Korea), unless otherwise specified.

### Example 1

### Production of Metal Catalyst

### 1.1. Production of Metal Oxide

As an electrolyte solution, a solution containing 0.05 M AgNO₃ dissolved therein was used, and as a working electrode and a counter electrode, electrically conductive porous carbon paper (CP) having a sectional area of 1 cm² was used. An experiment was performed using a 2-electrdoe cell without using a reference electrode. The working electrode and the counter electrode were placed in the electrolyte solution containing the metal ion so as to be sufficiently immersed in the electrolyte solution containing the metal ion. At this time, a current in the form of a pulse was applied to the working electrode by applying an oxidizing current of +40 mA for 1 second each time and keeping in a pause state (0 mA) for 2 seconds; this cycle was repeated for 250 times (applying an electric charge of total +10 C), whereby silver oxide (metal oxide) having a polyhedral structure having a bipyramidal shape was electrodeposited on the surface of the working electrode.

### 1.2. Production of Metal Catalyst Having Pores

The working electrode having the silver oxide (metal oxide) electrodeposited thereon was placed in a KOH electrolyte, and the counter electrode was replaced with electrically conductive activated carbon cloth (ACC), and Hg/HgO was used as a reference electrode. Therefore, a reducing potential was applied to the working electrode, so that the silver oxide (metal oxide) was reduced to form pores in the surface and interior part, thereby producing a mesoporous silver (metal) catalyst having oxygen remaining therein according to the present disclosure.

### Experimental Example 1

### Analysis of Structure of Metal Catalyst

### 1.1. Analysis of Microstructure of Metal Catalyst

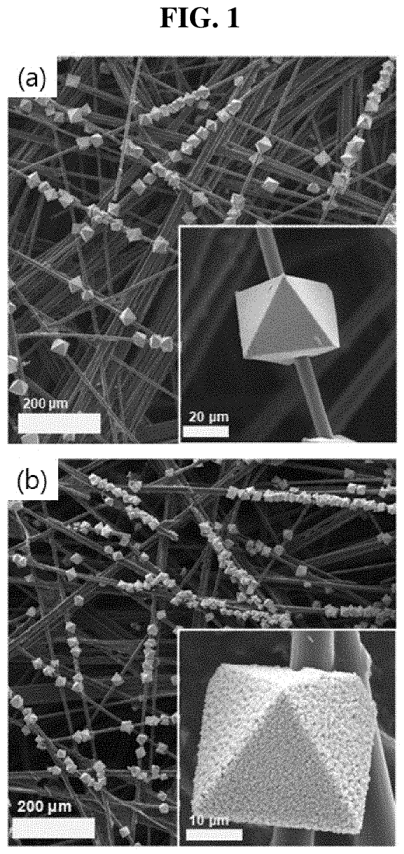

In order to analyze the surface microstructure of the surface of the metal catalyst produced by the production method of the present disclosure, the metal oxide (silver oxide) and metal catalyst (silver catalyst) produced in Example 1 were imaged by scanning electron microscopy (SEM), and the resulting SEM images are shown in FIG. 1.

Referring to FIG. 1, (a) it can be confirmed that the metal oxide (silver oxide) produced in Example 1 had a particle size of about 40 μm and had a polyhedral structure having a bipyramidal shape. Referring to (b), it can be confirmed that the silver catalyst obtained by applying the reducing current to the metal oxide (silver oxide) had a particle size of about 30 μm. In addition, it can be confirmed that, while the metal oxide (silver oxide) maintained its polyhedral structure having a bipyramidal shape, the silver catalyst having mesopores formed on the surface (outside) and inside of the polyhedral structure was produced.

The mesopores formed on the surface (outside) and inside of the metal catalyst may be atomic scale voids created as oxygen atoms present in the metal oxide escaped during the reduction of the metal oxide.

### 1.2. Analysis of Metal Catalyst

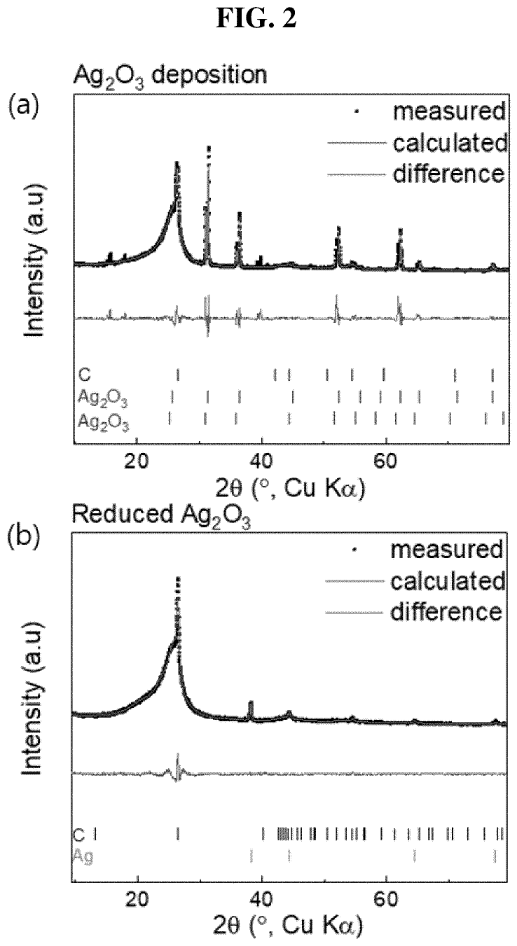

In order to analyze the structure of the metal catalyst produced by the production method of the present disclosure, X-ray diffraction (XRD) patterns of the metal oxide (silver oxide) and metal catalyst (silver catalyst) produced in Example 1 were measured, and the measured XRD patterns are shown in FIG. 2.

Referring to FIG. 2, (a) it can be confirmed that the XRD pattern of the metal oxide (silver oxide) produced in Example 1 is consistent with that of Ag₂O₃. In addition, referring to (b), it can be confirmed that the XRD pattern of the silver catalyst obtained by applying the reducing current to the metal oxide (silver oxide) is consistent with that of silver (Ag).

From the above results, it can be confirmed that the metal catalyst according to the present disclosure has pores formed on the surface (outside) and inside thereof, and was produced as a metal catalyst.

### Experimental Example 2

### Analysis of Oxygen Remaining in Metal Catalyst Following Application of Reducing Potential

### 2.1. X-Ray Diffraction (XRD) Analysis

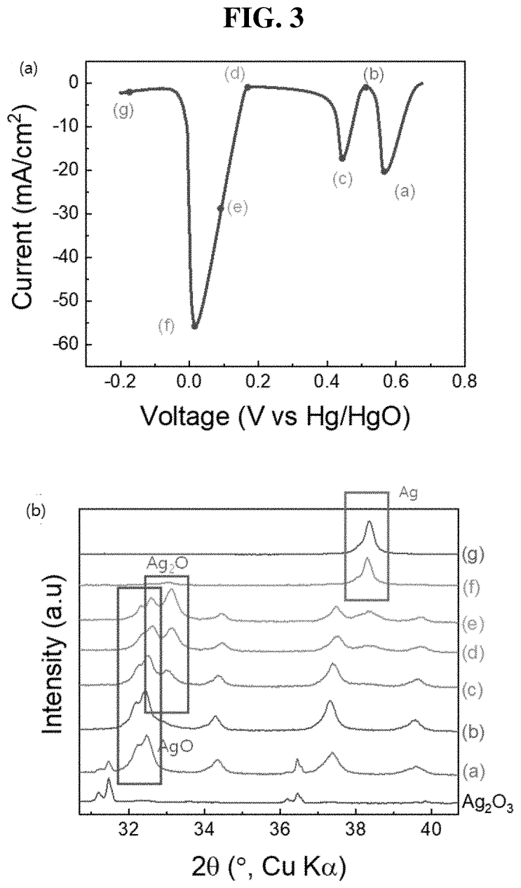

In order to analyze the amount of oxygen remaining in the metal catalyst depending on the degree of application of the reducing potential, an experiment was performed in the same manner as in Example 1, except that the reducing potential was applied as shown in FIG. 3(a) and the amount of residual oxygen in the produced metal catalyst was analyzed by the XRD pattern of the produced metal catalyst. The results of the analysis are shown in FIG. 3.

Referring to FIG. 3, it can be confirmed that the amount of oxygen remaining in the metal catalyst can be controlled to Ag₂O₃, Ag₂O₂, Ag₂O and Ag by controlling the degree of reduction.

### 2.2. X-Ray Photoelectron Spectroscopy (XPS)

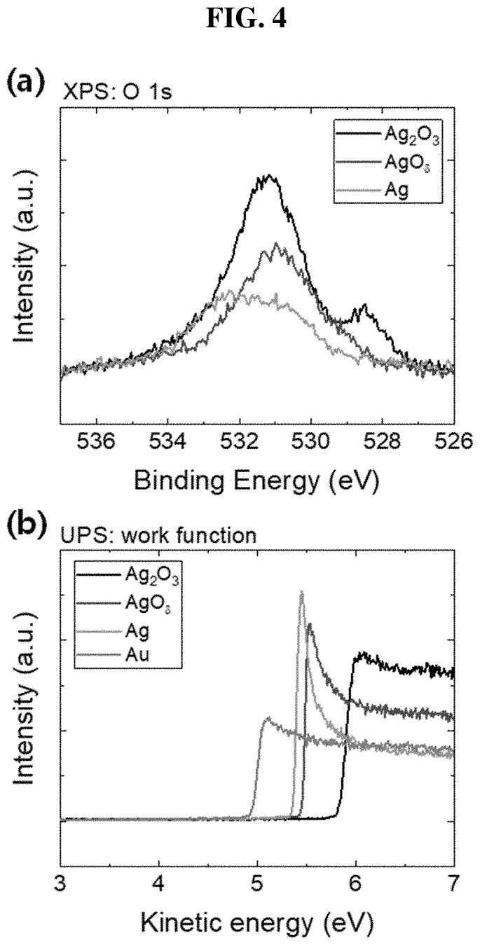

In order to analyze the amount of oxygen remaining in the metal catalyst depending on the degree of application of the reducing potential, the amount of oxygen remaining in the metal catalyst having pores formed thereon, which was produced by reduction in Example 1, was analyzed by the X-ray photoelectron spectroscopy spectrum of the metal catalyst. The results of the analysis are shown in FIG. 4.

Referring to FIG. 4(a), it can be confirmed that the chemical environment of oxygen remaining after the reduction reaction was similar to that of Ag₂O₃ before the reduction reaction. It can be seen that the above result has a distinct difference from the chemical environment of oxygen generated on the metal surface. Referring to FIG. 4(b), it can be confirmed that the work function representing the physical properties of the surface of the metal catalyst also lies in the middle between the metal and the metal oxide, suggesting that oxygen remains in the metal catalyst.

### Experimental Example 3

### Analysis of Capacitance of Metal Catalyst

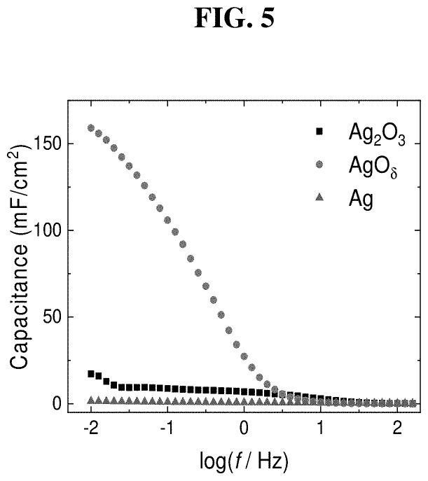

In order to examine the active area (surface area) of the metal catalyst from the capacitance thereof, the metal oxide (silver oxide) produced in Example 1.1, the porous metal produced by reducing the metal oxide in Example 1.2, and a silver catalyst electrodeposited according to a conventional method, were characterized by electrochemical impedance spectroscopy to measure their capacitances at 0.2 V (vs Hg/HgO). The results of the measurements are shown in FIG. 5.

Referring to FIG. 5, it can be confirmed that the metal oxide (silver oxide; black square) produced in Example 1.1 had a capacitance of 17.2 mF/cm², whereas the porous silver metal (red circle) produced in Example 1.2 has a capacitance of 159.1 mF/cm², which is about 10 times higher than that of the metal oxide. Meanwhile, it can be confirmed that the silver metal (blue triangle) electrodeposited by a conventional method of applying a negative current from the beginning has a capacity of 1.5 mF/cm².

Capacitance is generally proportional to the electrochemically active area of the electrode. Thus, from the above results, it can be confirmed that the porous metal catalyst produced according to the present disclosure has an active area which is at least 100 times higher than the metal electrodeposited by the conventional method.

### Experimental Example 4

### Analysis of Oxygen Reduction Catalytic Activity

### 4.1 Rotating Disk Electrode (RDE) Experiment

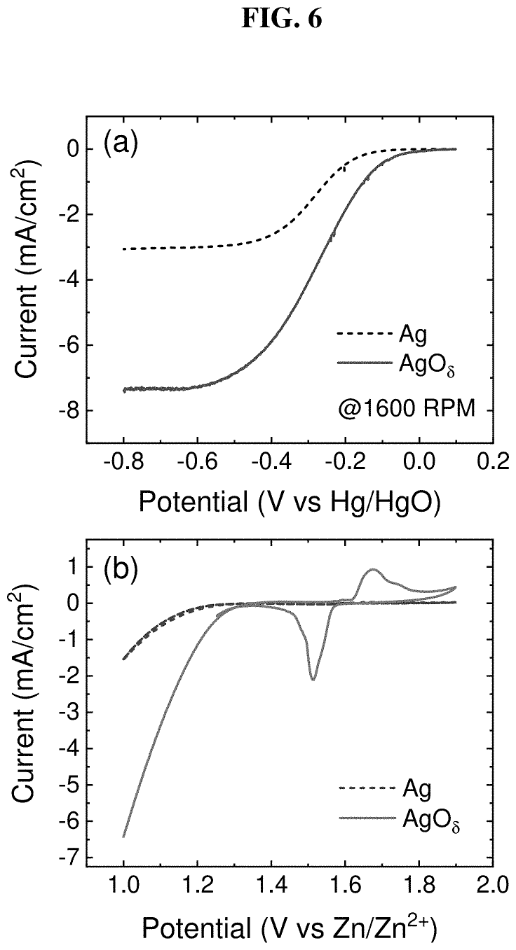

In order to analyze the oxygen-reducing activity of the metal catalyst produced according to the present disclosure, the metal catalyst (silver catalyst) produced in Example 1 was added into a 0.1 M KOH electrolyte and subjected to a rotating disk electrode (RDE) at 1,600 rpm while oxygen gas was allowed to flow into the electrolyte, thereby measuring the oxygen reduction limiting current value of the metal catalyst. In addition, for comparison with the oxygen reduction limiting current value of the metal catalyst according to the present disclosure, the same experiment was performed using, as a control, a silver metal electrodeposited by a conventional method. The results of the measurement are shown in FIG. 6(a).

Referring to FIG. 6(a), it can be confirmed that the silver metal (black dot line) electrodeposited by a conventional method has an oxygen reduction limiting current value of −3.0 mA/cm². On the other hand, it can be confirmed that the metal catalyst (red line) according to the present disclosure has an oxygen reduction limiting current value of −7.3 mA/cm², which is about twice higher than that of the silver metal (black dot line) produced by the conventional method.

### 4.2 Cyclic Voltammetry Experiment with Meniscus Method

In order to analyze the oxygen-reducing activity of the metal catalyst produced according to the present disclosure, a zinc-air cell was prepared, consisting of: a counter electrode and reference electrode made of zinc metal; and an electrolyte solution composed of 8.5 M KOH and 0.31 M ZnO. Using the zinc-air cell and using, as a working electrode, each of the metal catalyst (silver catalyst; red line) produced in Example 1 and a silver metal (black dot line) produced by a conventional method, an oxygen reduction reaction was performed at around 1.0 V (vs Zn/Zn²⁺). The results are shown in FIG. 6(b).

Referring to FIG. 6(b), it can be confirmed that the silver metal (black dot line) produced by the conventional method has an oxygen reduction current value of −1.55 mA/cm². On the other hand, it can be confirmed that the metal catalyst (silver catalyst; red line) produced in Example 1 has an oxygen reduction current value of −6.43 mA/cm².

From the above results, it can be confirmed that the metal catalyst having pores and residual oxygen formed in the metal through the reduction reaction according to the present disclosure exhibits significantly improved oxygen-reducing activity compared to the conventional metal catalyst.

### Experimental Example 5

### Analysis of Carbon Dioxide Reduction Catalytic Activity

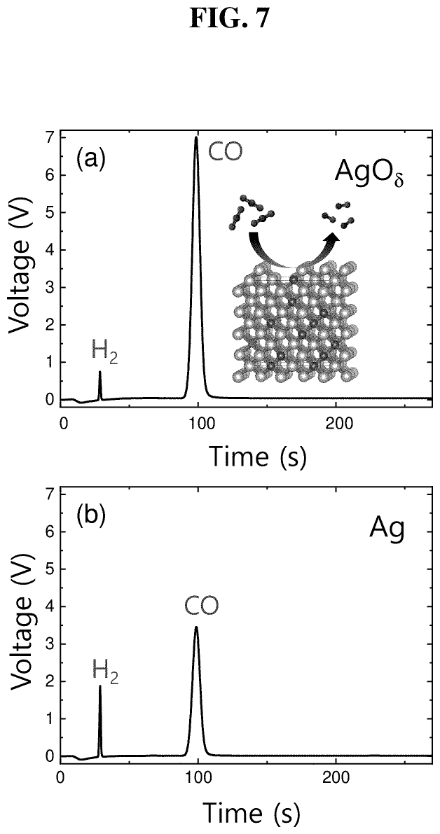

An experiment was performed to confirm whether the metal catalyst (silver catalyst) produced in Example 1 and the silver metal produced by a conventional method would have carbon dioxide selectivity in the reduction reaction of carbon dioxide. The results of the experiment are shown in FIG. 7.

Referring to FIG. 7, it can be confirmed that the metal catalyst (silver catalyst;(a)) produced in Example 1 can significantly lower the generation of H₂, which is a side reaction, during carbon dioxide reduction, compared to the silver metal produced by the conventional method, and has high carbon dioxide selectivity, that is, high Faraday efficiency.

From the above results, it can be confirmed that the metal catalyst according to the present disclosure may have excellent activity as a carbon dioxide reduction catalyst because it has mesopores and residual oxygen formed on the surface (outside) and inside thereof.

The above description of the present disclosure is exemplary, and those of ordinary skill in the art will appreciate that the present disclosure can be embodied in other specific forms without departing from the technical spirit or essential characteristics of the present invention. Therefore, it should be understood that the embodiments described above are exemplary in all aspects and are not restrictive.

1. A method for producing a metal catalyst, the method comprising steps of:
(S1) electrodepositing a metal oxide on a working electrode by applying an anodic or positive (+) current to the working electrode; and
(S2) producing a metal catalyst having pores and residual oxygen formed therein by applying a cathodic or negative (−) current or applying a potential in a negative (−) direction to the working electrode having the metal oxide electrodeposited thereon.

2. The method of claim 1, wherein the anodic or positive (+) current is applied in the form of a pulse by applying a current of +20 to +60 mA, pausing at 0 mA, and repeating the application of the current and the pausing.

3. The method of claim 1, wherein step (S1) comprises steps of:
(S1A) placing the working electrode and a counter electrode in a first electrolyte solution containing metal ions; and
(S1B) electrodepositing the metal oxide on a surface of the working electrode by applying the anodic or positive (+) current to the working electrode.

4. The method of claim 3, further comprising, after step (S1), a step of replacing the first electrolyte solution containing the metal ions with a second electrolyte solution containing no metal ion.

5. A metal catalyst having pores and residual oxygen formed therein, which is produced according to the method of claim 1.
